(19) United States
(12) Patent Application Publication
(10) Pub. No.: US 2024/0028498 A1
(43) Pub. Date: Jan. 25, 2024

(54) DYNAMICALLY CAPTURING DEBUG LOGS DURING RUNTIME

(71) Applicant: VMWARE, INC., Palo Alto, CA (US)

(72) Inventors: ANERI RAJIV DESAI, Pune (IN); Manisha Gambhir PAREKH, Pune (IN); Anand JaySingh BHALERAO, Pune (IN); Amit Ratnapal SANGODKAR, Pune (IN)

(21) Appl. No.: 17/965,846

(22) Filed: Oct. 14, 2022

(30) Foreign Application Priority Data
Jul. 22, 2022 (IN) 202241041950

(51) Int. Cl. G06F 11/36; G06F 8/41

(52) U.S. Cl. CPC G06F 11/366; G06F 8/427; G06F 11/364

(57) ABSTRACT

Systems and methods are described herein for dynamic debug logging during application runtime. In an example, a wrapper can be added to the code for functions of the application. During runtime, the wrapper can cause the functions to retain certain debug data. In one example, a function call graph can be constructed, which can include all the possible function call paths for the application. When an error occurs, if the application does not have a stack trace tool or API available, the application can use the function call graph to determine all possible function call paths between the entrant function and the errored function. If an application does have a stack trace tool or API, then the application can retrieve the actual function call path that led to the error. The application can enable a debug flag in the wrapper for each function in the function call path, which can cause those functions to log runtime debug data.

### RELATED APPLICATIONS

Benefit is claimed under 35 U.S.C. 119(a)-(d) to Foreign Application Serial No. 202241041950 filed in India entitled “DYNAMICALLY CAPTURING DEBUG LOGS DURING RUNTIME”, on Jul. 22, 2022, by VMware, Inc., which is herein incorporated in its entirety by reference for all purposes

The present application (Attorney Docket No. 1232.02) is related in subject matter to U.S. patent application Ser. No. 17/965,808 (Attorney Docket No. 1232.01), which is incorporated herein by reference.

### BACKGROUND

Currently, in a production environment, applications enable logging when an error occurs. The logs create a trail of data that can be used to identify the cause of the error. The logging typically begins after an error is detected and only includes logs above a certain error threshold. One problem with this is that the root cause of an error can occur before the error is detected, or the root cause may not trigger a high enough error threshold level. For example, an event that causes an error can occur during the execution of one function that affects the execution of subsequent functions. Numerous functions can execute before an error is detected. In such cases, logs created after the error occurs do not include information about what occurred before the error. Also, the application may not even collect a log on the function that caused the error because the application did not detect the error at that function.

This can make it impossible to identify the root cause without further investigation. For example, a representative may have to go back to customer to re-run the application in debug mode and collect logs with logging levels below the error threshold and re-run the application to capture the detailed flow of events. Re-running the application in debug mode has many drawbacks. For example, the representative may not be able to reproduce the issue. Also, the application will collect logs for all events, which takes significant time to parse through. The relevant debug logs can be easily missed due to the large number of logs required for manual review.

Current solutions to the problem have drawbacks as well. For example, some solutions use a buffer where the application maintains a set amount of debug logs in a forward fashion while the application executes. When an error occurs, a representative can go through the buffered logs. However, the application is limited to a predetermined amount of memory space for buffering debug logs, and the oldest logs are deleted as new logs are added. Because of this, relevant logs can be deleted before the error is detected, which in turn requires manual debugging. Additionally, buffering solutions make no distinction between what logs that may be relevant versus those that may not be. As a result, a representative must still parse through the logs to try to identify the relevant logs. This is time consuming and subject to manual errors.

As a result, a need exists for improved application debugging.

### SUMMARY

Examples described herein include systems and methods for dynamically capturing debug logs during runtime. The methods described herein include the collection of debug logs from functions in the function call path between an entrant function and a function that encountered an error. As used herein, the term “function call path” can refer to an order of functions called to run during runtime of an application. Some programming languages, such as JAVA and PYTHON, include an Application Programming Interface (“API”) for running a stack trace to identify the actual function call path leading up to the error. Some operating systems have built-in stack trace APIs, such as glibc and boost for Linux. Some programming languages do not include such a stack trace API. Examples are described herein for collecting debug logs during runtime for both applications with and application without a stack trace API available.

In an example for applications without a stack trace API available, a function call graph can be created when the application is initiated. A function call graph can provide a detailed relationship between caller and callee functions of the application. For example, the function call graph can detail which functions call one another during runtime. The graph can branch out from an entrant function, which is the first function to run for the application or a thread in the application. The function call graph can be constructed from disassembled code or constructed statically at initialization time.

Additional functionality can be added to each function for obtaining debug data in real-time when a function errors. There are various ways that additional functionality can be added to a function. For example, additional functionality can be added using a wrapper function, an API, or by injecting code. References are made herein to wrapper functions (hereinafter referred to interchangeably with simply “wrapper”) for adding functionality to a function. Those references are merely used as examples and are not intended to be limiting in any way. For simplicity, wrapper functions can encompass any method for adding functionality, such as using an API or injecting code. Wrappers can include runtime commands, post-error commands, or both. One runtime command can cause a function, when called, to store registered variables at entry point and exit point. The value of the registered variables can be different for each function at entry point and exit point. Post-error commands can be triggered when a debug flag is enabled. For example, the wrappers can include a post-error command for logging debug data to a log file, such as the stored registered variables and data about the function's stack frame.

When an error occurs, the application can use the function call graph to identify all the possible function call paths between the entrant function and the errored function. The application can then enable the debug flags for the functions in the possible function paths. Enabling the debug flags can cause the functions to execute the post-error commands in the wrapper. This can include logging data defined by the post-error commands. Once the debug logs are created, the application can disable the debug flags.

Dynamically creating debug logs in this manner provides runtime debug data from only the functions that could have caused the error. It also ensures that the debug log file includes runtime data from the function that initially caused the error. Debug data is not collected from functions that could not have been the root cause of the error because they are not part of the errored function's call path.

In an example for applications that include a stack trace API, similar wrappers as described above can be added to the code for each function of the application for which debug logs may be needed. These wrappers can cause the functions to retain certain data during runtime and collect certain data if the debug flag is enabled. When an error occurs, the application can use the stack trace API. The stack trace API can return the actual function call path that led to the error. The application can then enable debug flags at only the functions in the function call path. Enabling the debug flag can cause those functions to retrieve and log debug data as defined in the wrapper. Once the debug logs are created, the application can disable the debug flags. In one example, the wrapper can include a subfunction that disables the debug flag after the logs are created. For recursive functions, the debug flag can be a counter.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for dynamically capturing debug logs.

FIG. 2 is an illustration of an example function call graph.

FIG. 3 is an illustration of an example method of retracing a function call graph.

FIG. 4 is a sequence diagram of an example method for dynamically capturing debug logs.

FIG. 5 is another flowchart of an example method for dynamically capturing debug logs.

FIG. 6 is a sequence diagram of another example method for dynamically capturing debug logs.

FIG. 7 is an illustration of an example system for dynamically capturing debug logs.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

The methods described herein relate to collecting debug logs from application functions in the function call path of a function that encountered an error. A function describes the internal behavior of a component needed to realize one or more application services. Each time a function is called in a program, a block of memory called a stack frame (also called an activation frame or activation record) is allocated on top of a call stack. A call stack generally stores the function's arguments and local register variables. The variables allow the call stack to keep track of the point to which each active function should return control when it finishes executing. For example, when a first function calls a second function, first functions' return address is saved in a stack frame. The return address causes execution to leave the first function to the second function. When the second function has completed execution, the return address is used to resume the first function at the point in the code immediately after execution was passed to the second function.

Stack frames can be nested inside each other based on layers of calls that occur before execution is returned. The stack frames of an application thread make up a call stack. A call stack therefore includes the state of each nested function at a point in time. The methods described herein leverage this knowledge retrieving information from the nested stack layers at the point in time that a function in the corresponding thread encounters an error. This provides information about the stack frames during runtime, thereby eliminating the need to reproduce the error.

Some programming languages have built-in support for retrieving a stack trace using system calls. For example, PYTHON's traceback module includes various functions for producing a stack trace. JAVA includes multiple methods for retrieving a stack trace of a thread, including dumpstack( ) and printstacktrace( ). A method is a block of code which only runs when it is called. Linux includes native stack trace API support. However, some programming languages do not have library support for obtaining a stack trace when running in an operating system without a built-in stack trace API.

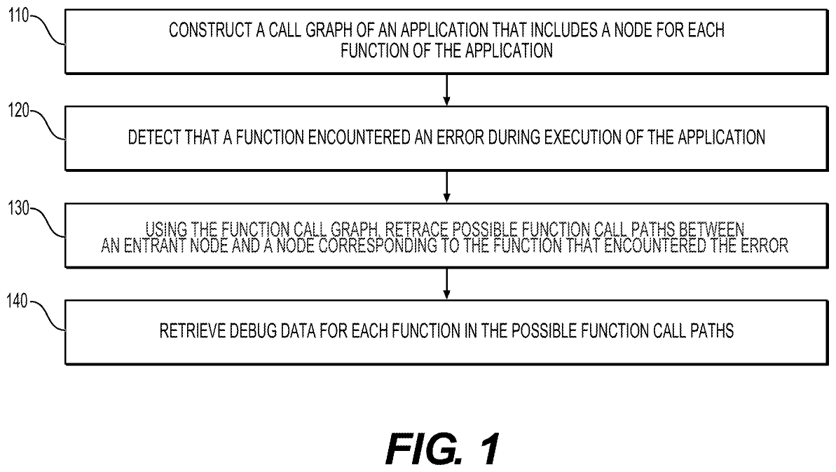

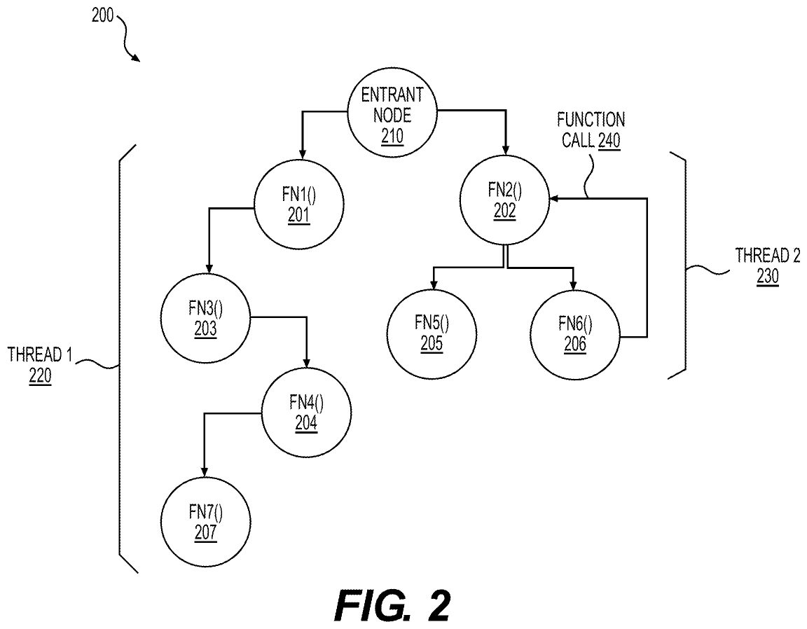

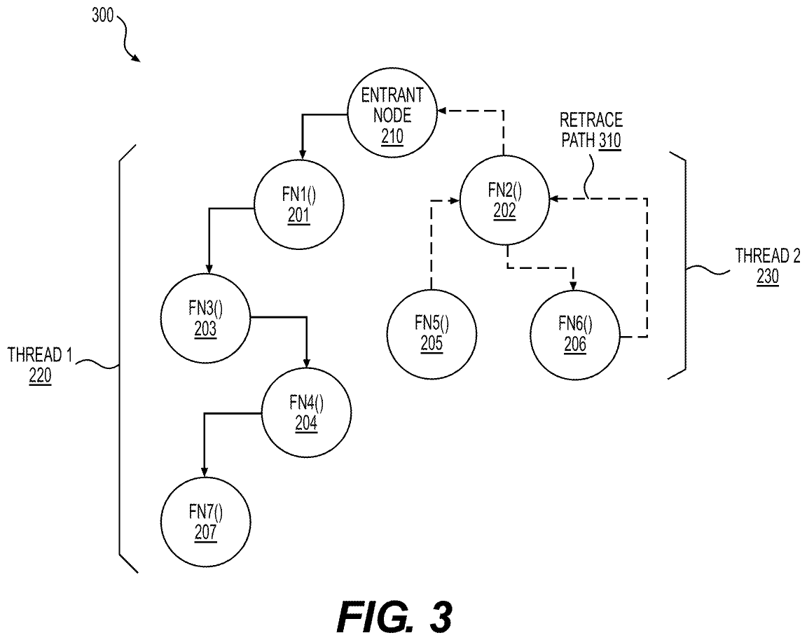

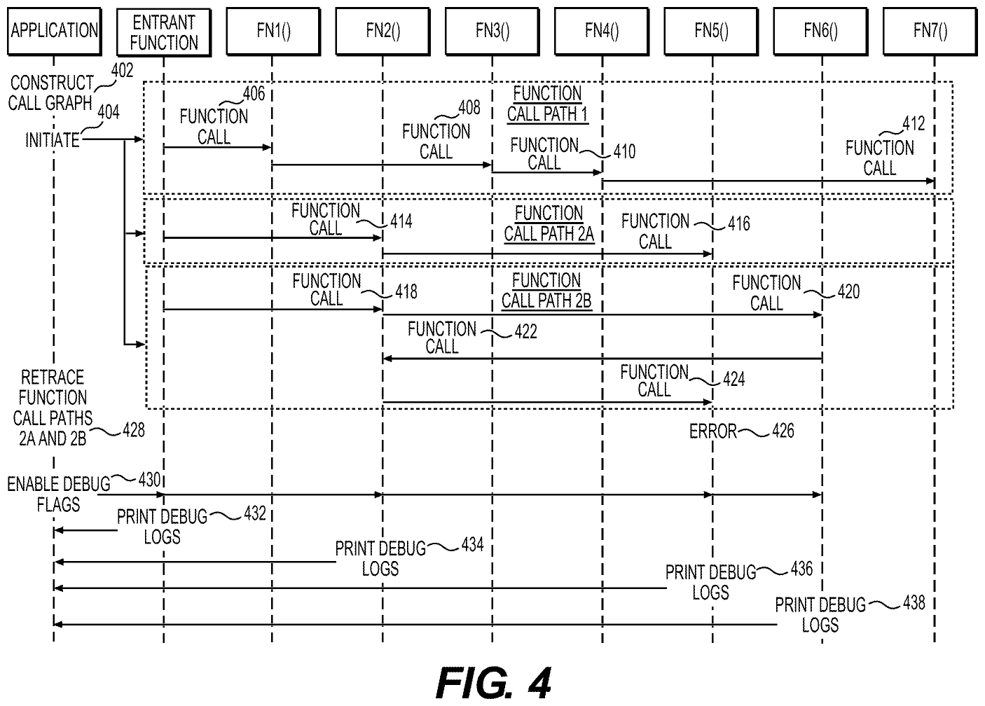

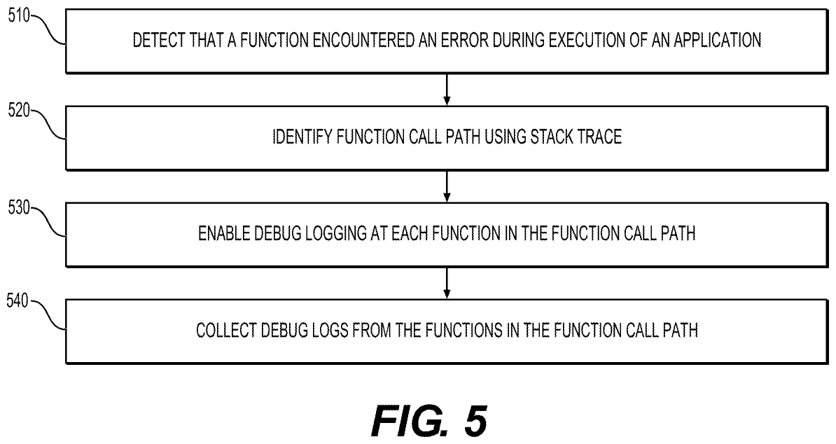

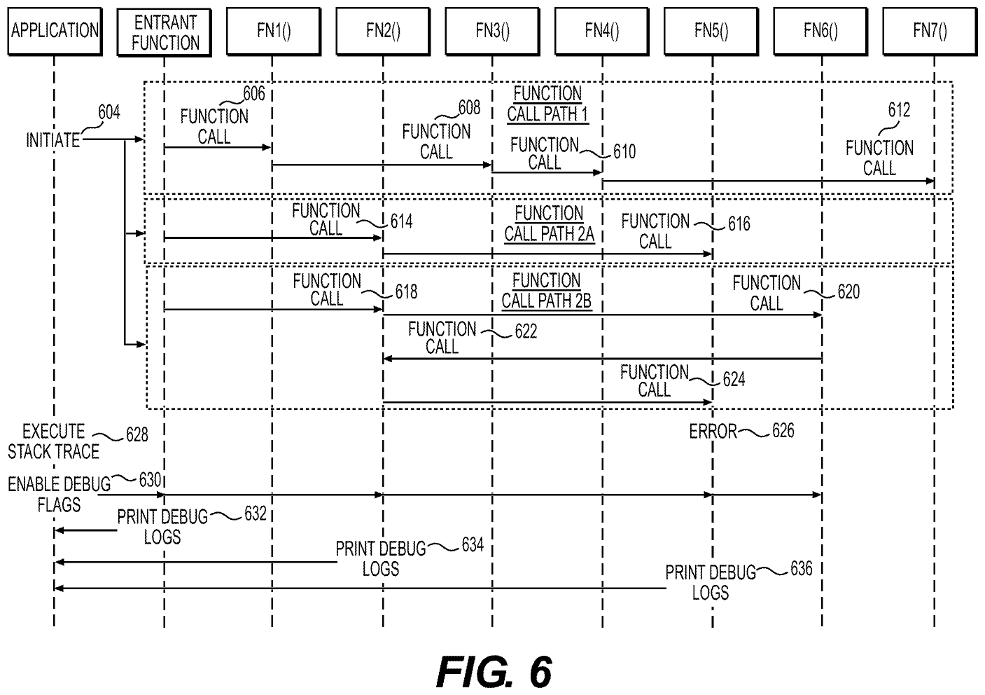

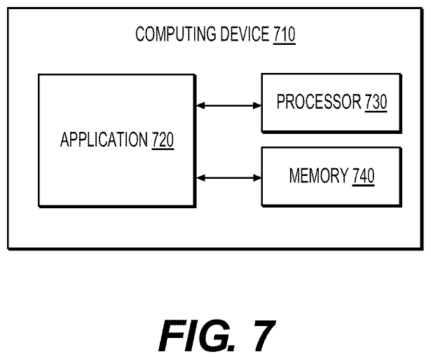

Methods are described herein for retrieving time debug logs at runtime for both applications that have stack trace capabilities and those that do not. FIGS. 1 and 4 are directed to applications without stack tracing capability. FIG. 2 includes an example illustration of a function call graph that can be created for applications without stack tracing capability. FIG. 3 is an example illustration of retracing function call paths using the function call graph from FIG. 2. FIGS. 5 and 6 are directed to applications that have stack tracing capability. FIG. 7 illustrates an example system for dynamically capturing debug logs.

FIG. 1 is a flowchart of an example method for dynamically capturing debug logs without using built-in support for stack tracing. At stage 110, an application can construct a function call graph. A function call graph can provide a detailed relationship between caller and callee functions of the application. In other words, a function call graph can provide the possible call stack layouts of the application. The function call graph can be constructed from disassembled code of a binary application. There are various available tools that give assembly information of what a function does, including, for example, objdump, TDUMP, MICROSOFT COFF BINARY FILE DUMPER (“DUMPBIN”), and so on. Objdump is a command-line program for displaying various information about object files on Unix-like operating systems. TDUMP is a WINDOWS executable that breaks apart a file structurally and uses the file's extension to determine the output display format. DUMPBIN displays information about Common Object File Format (“COFF”) binary files. The function call graph can be constructed by parsing the disassembled code at compile time or, alternatively, it can be constructed statically at initialization time.

The function call graph can include a node for each function, and the nodes can include pointers that directionally link functions based on caller/callee relationships between them. The nodes can include a debug flag that indicates where debug logs should be logged. The debug flags can be disabled by default. When an error occurs during execution of the application, the application enable the debug flags on certain nodes, which can cause those nodes to collect debug logs. This is described in more detail later regarding stage 140. The nodes can also include a buffer where each function can mark registered variables at entry point and at exit point. Entry point refers to when the execution of the function begins, and exit point refers to when the execution of the function ends. These variables can be retrieved from the buffer when the debug flag is enabled for the function.

Moving temporarily to FIG. 2, an example function call graph 200 is illustrated. Each function call graph can include an entrant node 210, which represents the first function of the application to run (referred to throughout as the “entrant function”). The entrant function can then call other functions to run. Each function that the entrant function calls begins a new thread. A called function that begins a thread becomes an entrant function for that thread. The function call graph 200 includes two threads: thread 1 220 and thread 2 230. Thread 1 220 includes four nodes representing four different functions of the application: fn1( ) 201, fn3( ) 203, fn4( ) 204, and fn7( ) 207. In the thread 1 220, the fn1( ) 201 can be treated as the thread's entrant function. Thread 2 230 includes three nodes representing three different functions: fn2( ) 202, fn5( ) 205, and fn6( ) 206. In the thread 2 230, the fn2( ) 202 can be treated as the thread's entrant function. As used herein, except for entrant functions, a function corresponding to a node from the function call graph 200 is referred to using the name of the node followed by “function.” For example, the function represented by the node fn1( ) 201 is referred to as the fn1( ) function.

The various nodes are connected by call edges 240. An arrow on the call edges 240 represents the direction of a call. For example, the call edge 240 between the entrant node 210 and fn2( ) 202 indicates that the entrant function calls the fn2( ) function. In other words, the entrant function is the caller and the fn2( ) function is the callee. The call edges 240 can be used to trace the possible function call paths. For example, the thread 1 220 shows that the entrant function calls the fn1( ) function, which calls the fn3( ) function, which calls the fn4( ) function, which calls the fn70 function. The thread 2 230 includes multiple possible calls paths. For example, as shown, in one possible call path the entrant function calls the fn2( ) function, which calls the fn5( ) function. Alternatively, the entrant function can call the fn2( ) function, which calls the fn6( ) function, which then calls the fn2( ) function. The fn2( ) and fn6( ) functions can continue to call each other until the fn2( ) function calls the fn5( ) function.

Returning to FIG. 1, at stage 120, the application can detect that a function encountered an error. For example, a function can encounter a runtime error, which is an error that occurs at the time of running or executing the application. Some applications include functions specifically for detecting and handling certain types of errors. If the detecting function is unable to resolve the error, then the detecting function throws an exception. An exception is an anomaly that occurs during the normal flow of an application that prevents it from continuing.

At stage 130, using the function call graph, the application can retrace the possible call paths between the errored function and the entrant function. The application can include a specific function for retracing function call paths. The retracing function can be triggered whenever an error occurs. The retracing function can retrace the possible function call paths using the previously described pointers that directionally link functions based on caller/callee relationships between them.

The application can retrace the call paths using an algorithm, such as a depth-first search (“DFS”) algorithm. A DFS algorithm traverses or searches tree or graph data structures by starting at a root node (e.g., the errored node) and exploring as far as possible along each branch before backtracking.

Moving temporarily to FIG. 3, an example function call graph 300 is illustrated that shows possible retraced paths for the function call graph 200 from FIG. 2. Elements in FIGS. 2 and 3 with like numbers can correspond to the same component. For example, the entrant node 210 in both FIGS. 2 and 3 can correspond to the same entrant function. The function call graph 300 differs in that it includes retraced paths 310, which are illustrated by the dashed lines with arrows to indicate the retrace direction.

The function call graph 300 illustrates possible retrace paths 310 when an error occurs at fn5( ) 205. For example, one possible path can go from fn5( ) 205 to fn2( ) 202. Another possible path can go from fn5( ) 205 to fn2( ) 202, then to fn6( ) 206, and back to fn2( ) 202. Once the retracing function reaches fn2( ) 202, the possible path can end. So, for example, when an error occurs in any function from the thread 2 230, the retracing function does not need to do any retracing in the thread 1 220. This effectively filters out debug data that would be irrelevant in identifying the root cause of the error, thereby reducing the time required to debug.

Returning to FIG. 1, at stage 140, the application can retrieve the debug data for each function in the retraced paths. In an example, the application can retrieve the debug data by enabling a debug flag at the functions in the possible function call paths. The debug flags can be part of wrapper functions added to the code of the application. A wrapper can be added to each function in the application for which debug logs may be needed. The wrappers functions can include runtime commands, post-error commands, or both. For example, because registered variables can change during runtime, a wrapper can cause its corresponding function to retain registered variables at entry point and exit point each time the function is called. These variables can then be retrieved if a function in the function call path encounters an error. Table 1 below includes an example of such a wrapper written in C.

TABLE 1

```
void BT_INIT_VAR_INFO(const char *func, func_list_t *ptr,
void *var, char format) {
  ptr−>info.value[ptr−>info.cnt] = var;
  ptr−>info.format[ptr−>info.cnt] = format;
  if (format == ‘s') {
    snprintf(&ptr−>inf.init[ptr−>info.cnt][0], 100,
    “%s: %s/n”, func/ (char *0)var);
  }
  if (ptr−>info.format[ptr−>info.cnt] == ‘d’) {
    snprintf(&ptr−>inf.init[ptr−>info.cnt][0], 100,
    “%s: %s/n”, func/ (char *0)var);
  }
  ptr−>inf.cnt++
}
```

Post-error commands can execute when a debug flag in the wrapper is enabled. For example, when a function's debug flag is enabled, the function can execute one or more log commands that log the debug data. For example, the functions can log the registered variables that were previously retained and log information about the function's stack frame. The debug data from all the functions in the possible function call paths can log their debug data to the same data file that a user can then access for troubleshooting, such as a .log file. This provides the user with a log file with runtime data about functions in all the possible function call paths leading to the errored function, but the log file does not include any debug data from functions of other threads that would not be relevant to debugging the errored function. Table 2 below includes an example of such a wrapper written in C.

```
TABLE 2
void BT_PRINT_VAR_INFO (const char *func, func_list_t *ptr) {
  if (ptr−>flag) {
    ptr0>inf.cnt--;
    int i = ptr−>info.cnt;
    if (ptr−>info.format[i] == ‘s') {
      printf(“%s: var %d: %s, init: %s/n”, func, i,
        (char *)ptr−>info.value[i], ptr-?info.init[i]);
    }
    if (ptr−>info.format[i] == ‘d’) {
      printf(“%s var %d: %d, init: %s/n”, func, i,
        *(int *)ptr−>info.value[i], ptr−>info.init[i]);
    }
    ptr−>flag--;
  }
}
```

In an example, the retracing function described at stage 130 can enable the debug flags as it identifies the functions in the possible call paths. After the functions log their debug data, the retracing function can disable the debug flags. Returning to FIG. 3 as an example, the retracing function can enable the debug flag at the fn5( ) function. The fn5( ) function can then log its debug data. Once the debug data is logged, the retracing function can disable debug flag at the fn5( ) function and move to the fn2( ) function. The retracing function can continue this process for the fn2( ) function, the fn6( ) function, and the entrant function. If a function runs multiple times, then it can have multiple iterations in the call stack. This can happen, as an example, when the fn2( ) function calls the fn6( ) function at least once before calling the fn5( ) function. The fn2( ) function would be called once by the entrant function and at least once by the fn6( ) function, thereby creating at least two iterations of the fn2( ) function. In such instances, the debug flag can cause the function to log debug data for each iteration.

FIG. 4 is a sequence diagram of an example method for dynamically capturing debug logs. At stage 402, the application can construct a function call graph. The function call graph can be constructed from disassembled code of the application. There are a variety of tools and APIs that can be used to construct the function call graph, such as objdump, TDUMP, or DUMPBIN. The application can construct the function call graph using the data provided by one of these tools. The function call graph can be constructed during compile or initialization time.

The function call graph can include a node for each function, and the nodes can include pointers that directionally link functions based on caller/callee relationships between them. The nodes can include a debug flag that indicates debug logs that should be logged. The nodes can also include a buffer where each function can mark registered variables at entry point and at exit point of the respective function.

At stage 404, the application can initiate the entrant function. The entrant function can be the first function that runs for the application. The entrant function can then call one or more functions to run. The sequence diagram includes three example call paths that are based on the function call graph 200 from FIG. 2. The function call path 1 corresponds to the thread 1 220. In the function call path 1, the entrant function calls the fn1( ) function at stage 406, the fn1( ) function calls the fn3( ) function at stage 408, the fn3( ) function calls the fn4( ) function at stage 410, and the fn4( ) function calls the fn7( ) function at stage 412.

The function call paths 2A and 2B correspond to possible function call paths in the thread 2 230. In the function call path 2A, the entrant function calls the fn2( ) function at stage 414, and the fn2( ) function calls the fn5( ) function at stage 416. In the function call path 2B, the entrant function calls the fn2( ) function at stage 418, the fn2( ) function calls the fn6( ) function at stage 420, the fn6( ) function calls the fn2( ) function at stage 422, and the fn2( ) function calls the fn5( ) function at stage 424.

At stage 426, the fn5( ) function can encounter an error. The error can be any kind of error, such as a runtime error. The application can detect the error by catching an exception. In response, at stage 428, the application can retrace the possible function call paths between the fn5( ) function and the entrant function using the function call graph. For example, the application can execute a retrace function that traverses the function call graph using a DFS algorithm. The application can retrace only the function call paths that include the fn5( ) function, which include the function call paths 2A and 2B. The application can ignore the function call path 1 because the fn5( ) function did not run in that call path.

At stage 430, the application can enable debug flags for all functions in the retraced paths (i.e. the function call paths 2A and 2B). This includes the entrant function, the fn2( ) function, the fn5( ) function, and the fn6( ) function. The functions with the debug flags enabled can then log their corresponding debug data, which can include the state of the function's stack and buffered entry and exit variable values. For example, the entrant function can log its debug data at stage 432, the fn2( ) function can log its debug data at stage 434, the fn5( ) function can log its debug data at stage 436, and the fn6( ) function can log its debug data at stage 438. In some examples, stages 432, 434, 436, and 438 can occur in reverse order. For example, the fn6( ) function can log its debug data, then the fn5( ) function can log its debug data, then the fn2( ) function can log its debug data, then the entrant function can log its debug data. Whether the entrant function logs debug data can depend on whether the application executes multiple threads. For example, if only thread 2 230 executes, then the entrant function can log debug data. On the other hand, if thread 1 220 and thread 2 230 both execute, then the fn2( ) function can serve as the entrant function for the thread, and stage 432 can be skipped. The debug data can be collected from a memory stack. In particular, each instance of the function can have its own frame in the stack where the variables are maintained. Those variables can be collected as debug data from the respective frame of the memory stack. Once the debug data is logged, the application can disable the debug flags.

FIG. 5 is a flowchart of an example method for dynamically capturing debug logs for applications that include built-in support for tracing a stack. For example, as described previously herein, JAVA and PYTHON include support for stack tracing. Also, some application written in C or C++ can use glibc's backtrace so long as compiler optimizations do not interfere. The example method described below leverages this stack tracing functionality to generate debug logs at runtime when an error occurs.

At stage 510, the application can detect that a function encountered an error. For example, a function can encounter a runtime error. Some applications include functions specifically for detecting and handling certain types of errors. If the detecting function is unable to resolve the error, then the detecting function throws an exception.

At stage 520, the application can determine the function call path using a stack trace tool or API. The function call path can be an ordered list of function calls that occurred leading up to the function that encountered an error. The application can determine the function call path using a built-in tool provided by the application's programming language. For example, if the application is written in JAVA, then the application can run getstacktrace( ) or dumpstack( ) to retrieve an ordered list of all the functions in the call stack for the thread with the error. If the application is written in PYTHON, then the application can run a function from the traceback module, such as traceback.print_stack. If the application is running in Linux or another operating system with a built-in stack trace API, then the application can retrieve the function call path from the stack trace API. The examples of stack trace tools and APIs mentioned herein are merely exemplary and not meant to be limiting in any way. For example, any stack tracing capability can be used that retrieves the function call path of the application between the entrant function and the errored function.

At stage 530, the application can enable debug logging at each function in the function call path. To do this, a wrapper can be added to the code for each function before the application runs. The wrappers can cause their corresponding functions to execute additional commands when the function is called. The wrappers functions can include runtime commands, post-error commands, or both. For example, because registered variables can change during runtime, a wrapper can cause its corresponding function to retain registered variables at entry point and exit point each time the function is called. These variables can then be retrieved if a function in the function call path encounters an error. An example of such a wrapper is included in Table 1 described previously. The wrappers can include a debug flag that causes certain commands in a wrapper to run only when enabled. For example, the wrappers can include a debug flag that, when enabled, cause debug data associated with the function to be logged. The application can therefore enable debug logging by enabling the debug flag in the wrapper for each function in the function call path. An example of such a wrapper is included in Table 2 described previously.

The wrappers can include commands that only execute when the debug flag is enabled. For example, when the debug flag is enabled, the function can log registered variables previously retained, and log the state of the function's stack.

At stage 540, the application can collect debug logs from the functions in the function call path. For example, when the application enables the debug flags, the corresponding functions can execute a subfunction from the wrapper that logs data as defined by the wrapper. As an example, when an error occurs, the application can execute a stack trace to identify functions in the function call path between the entrant function and the errored function. The application can then enable the debug flag at each of the identified functions. When a function's debug flag is enabled, the function can execute one or more log commands that log the debug data. For example, the functions can log registered variables that were previously retained and log information about the function's stack frame. The debug data from all the functions in the possible function call paths can log their debug data to the same data file that a user can then access for troubleshooting, such as a .log file. This provides the user with a log file with runtime data about only the functions in the function call path for the errored function.

FIG. 6 is a sequence diagram of another example method for dynamically capturing debug logs. At stage 604, the application can initiate the entrant function. The entrant function can then call one or more functions to run. Like the sequence diagram of FIG. 4 described previously, the sequence diagram in FIG. 6 includes three example call paths that are based on the function call graph 200 from FIG. 2. The entrant function can be the first function that runs for the application. The entrant function can then call one or more functions to run. The function call path 1 corresponds to the thread 1 220. In the function call path 1, the entrant function calls the fn1( ) function at stage 606, the fn1( ) function calls the fn3( ) function at stage 608, the fn3( ) function calls the fn4( ) function at stage 610, and the fn4( ) function calls the fn7( ) function at stage 612.

The function call paths 2A and 2B correspond to possible function call paths in the thread 2 230. In the function call path 2A, the entrant function calls the fn2( ) function at stage 614, and the fn2( ) function calls the fn5( ) function at stage 616. In the function call path 2B, the entrant function calls the fn2( ) function at stage 618, the fn2( ) function calls the fn6( ) function at stage 620, the fn6( ) function calls the fn2( ) function at stage 622, and the fn2( ) function calls the fn5( ) function at stage 624.

At stage 626, the fn5( ) function can encounter an error. The error can be any kind of error, such as a runtime error. For this example sequence diagram, the error occurred as part of function call path 2A. In response, at stage 628, the application can execute a stack trace. For example, if the application is written in JAVA, then the application can run getstacktrace( ) or dumpstack( ), if the application is written in PYTHON, then the application can run a function from the traceback module, such as traceback.print_stack, and if the application is written in C or C++ and the glibc library is installed, then the application can run a backtrace function. The stack trace can return the function call path for function call path 2A.

At stage 630, the application can enable debug logging at each function in the function call path 2A. Unlike in stage 430 of FIG. 4, the application does not enable debug logging for the function call path 2B. This is because the stack trace is able to provide the actual call path that led to the error. Debug logs are retrieved for function call path 2B at stage 430 because a stack trace is not available/used, so the debug data for all possible function call paths is needed.

The application can enable debug logging by enabling debug flags included in wrappers added to the code for each function. In an example, the application can run a function for enabling and disabling debug flags. For example, the stack trace can return identifiers (“IDs”) for each function in the call path. The application can input these IDs into the debug flag function, which causes the function to enable debug flags at the functions matching those IDs. In this example, the IDs correspond to the entrant function, fn20, and fn50, but not fn60.

The functions with the debug flags enabled can then log their corresponding debug data, which can include the state of the function's stack and entry and exit points values for registered variables. The functions can do this by running a log command with IDs for the debug data inputted into the log command. For example, the entrant function can log its debug data at stage 632, the fn2( ) function can log its debug data at stage 634, and the fn5( ) function can log its debug data at stage 636. Once the debug data is logged, the application can disable the debug flags.

FIG. 7 is an illustration of an example system for dynamically capturing debug logs. A computing device 710 can include an application 720. The computing device 710 can be one or more processor-based devices, such as a server (physical or virtual), personal computer, tablet, or cell phone. The application 720 can be any kind of software application. The application 720 can be installed on the computing device 710 or provided by a web server through a web browser on the computing device 710. For example, a web server can host back-end services of the application, and a front-end graphical user interface (“GUI”) can be provided to a web browser on the computing device 710. A processor 730 can execute instructions in the application's code to provide an interface of the application 720 to the user. For example, the processor 730 can be a central processing unit (“CPU”). The computing device 710 can include memory 740, which can be a form of computer memory for storing working data and machine code. As an example, the memory 740 can be random-access memory (“RAM”).

To execute the application 720, the processor 730 can execute instructions from the application's code. Some of the code can be stored in the memory 740 as the application 720 runs. For example, the application 720 can store call stacks for each thread of the application 720. The call stacks can include call frames for each function that runs. The application 720 can also store additional information in the memory 740 is defined in wrappers added to the code. For example, the application 720 can store the state of registered variables for each function an entry and exit point. If an error occurs, the registered variables and stack frame information for each function in the errored function's call path can be retried from the memory 740.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for dynamically capturing debug logs, comprising:
detecting that a function of an application encountered an error during execution of the application;
retrieving a function call path between an entrant function and the function that encountered the error by executing a stack trace;
enabling debug logging at each function in the function call path; and
retrieving debug data from each function in the function call path.

2. The method of claim 1, wherein each function in the function call path includes a wrapper that causes the corresponding function to store values of registered variables at entry point and exit point when the corresponding function is called.

3. The method of claim 2, wherein enabling debug logging at each function in the function call path includes enabling a debug flag included in each function's wrapper that causes the corresponding function to execute a subfunction for logging the debug data.

4. The method of claim 2, further comprising disabling the debug flag at each function in the function call path after the debug data is logged.

5. The method of claim 2, wherein the debug data for each function in the function call path includes the stored values of registered variables and a state of a memory stack for the corresponding function.

6. The method of claim 1, wherein the function call path includes a list of functions in a call stack for a thread in which the error occurred.

7. The method of claim 1, wherein retrieving debug data includes logging the debug data to a log file.

8. A non-transitory, computer-readable medium containing instructions that, when executed by a hardware-based processor, causes the processor to perform stages for dynamically capturing debug logs, the stages comprising:
detecting that a function of an application encountered an error during execution of the application;
retrieving a function call path between an entrant function and the function that encountered the error by executing a stack trace;
enabling debug logging at each function in the function call path; and
retrieving debug data from each function in the function call path.

9. The non-transitory, computer-readable medium of claim 8, wherein each function in the function call path includes a wrapper that causes the corresponding function to store values of registered variables at entry point and exit point when the corresponding function is called.

10. The non-transitory, computer-readable medium of claim 9, wherein enabling debug logging at each function in the function call path includes enabling a debug flag included in each function's wrapper that causes the corresponding function to execute a subfunction for logging the debug data.

11. The non-transitory, computer-readable medium of claim 9, further comprising disabling the debug flag at each function in the function call path after the debug data is logged.

12. The non-transitory, computer-readable medium of claim 9, wherein the debug data for each function in the function call path includes the stored values of registered variables and a state of a memory stack for the corresponding function.

13. The non-transitory, computer-readable medium of claim 8, wherein the function call path includes a list of functions in a call stack for a thread in which the error occurred.

14. The non-transitory, computer-readable medium of claim 8, wherein retrieving debug data includes logging the debug data to a log file.

15. A system for dynamically capturing debug logs, comprising:
a memory storage including a non-transitory, computer-readable medium comprising instructions; and
a hardware-based processor that executes the instructions to carry out stages comprising:
detecting that a function of an application encountered an error during execution of the application;
retrieving a function call path between an entrant function and the function that encountered the error by executing a stack trace;
enabling debug logging at each function in the function call path; and
retrieving debug data from each function in the function call path.

16. The system of claim 15, wherein each function in the function call path includes a wrapper that causes the corresponding function to store values of registered variables at entry point and exit point when the corresponding function is called.

17. The system of claim 16, wherein enabling debug logging at each function in the function call path includes enabling a debug flag included in each function's wrapper that causes the corresponding function to execute a subfunction for logging the debug data.

18. The system of claim 16, further comprising disabling the debug flag at each function in the function call path after the debug data is logged.

19. The system of claim 15, wherein the debug data for each function in the function call path includes the stored values of registered variables and a state of a memory stack for the corresponding function.

20. The system of claim 15, wherein the function call path includes a list of functions in a call stack for a thread in which the error occurred.
